(19) United States
(12) Patent Application Publication
(10) Pub. No.: US 2022/0134398 A1
(43) Pub. Date: May 5, 2022

(54) Recycling a Used Absorbent Hygiene Product or its Components Using Hydrothermal Treatment

(71) Applicant: The Procter & Gamble Company, Cincinnati, OH (US)

(72) Inventors: Dimitris Ioannis Collias, Mason, OH (US); Rodrigo Rosati, Frankfurt Am Main (DE)

(21) Appl. No.: 17/498,783

(22) Filed: Oct. 12, 2021

Related U.S. Application Data
(60) Provisional application No. 63/108,492, filed on Nov. 2, 2020.

(51) Int. Cl. B09B 3/00; C10G 9/36

(52) U.S. Cl. CPC B09B 3/0091; C10G 9/36

(57) ABSTRACT

Used AHP or its components is converted into low molecular weight hydrocarbons using HTT reactor. These low molecular weight hydrocarbons produce ethylene, propylene, and other chemicals when fed into a steam cracker, which can be used to produce recycled components of the AHP or a fully recycled AHP.

### FIELD OF THE INVENTION

The present invention generally relates to recycling of a used absorbent hygiene product (AHP) or its components, such as poly(acrylic acid)-based superabsorbent polymer (SAP), adhesive, polyethylene, polypropylene, polyester, and cellulose fibers, using hydrothermal treatment (HTT). More specifically, a used AHP, and optionally additional water, is fed into an HTT reactor, where the temperature and pressure are such that the water (either present in the used AHP as moisture, added to the used AHP, or in the HTT reactor) is converted into higher temperature and pressure water (HTPW). In the conditions of the HTT reactor, the HTPW degrades the used AHP and produces a liquid product stream. The liquid product stream comprises essentially low molecular weight hydrocarbons (i.e., C₆+), such as n-paraffins, isoparaffins, cycloparaffins, olefins, aromatics, or mixtures thereof, and has properties (e.g., viscosity, vapor pressure, sulfur content, aromaticity, hydrogen content, caloric value, etc.) which resemble those of naphtha, diesel, gasoline, or other fuels. The liquid product stream, comprising these waste-derived fuel products, is then fed into a steam cracker to produce ethylene, propylene, and other chemicals, which finally can be used to produce various AHP components from recycled AHP in a circular manner, such as polyethylene, polypropylene, polyester, SAP, etc., and a fully recycled AHP.

### BACKGROUND OF THE INVENTION

Recycling of AHPs (i.e., baby diapers, feminine-protection pads, and adult incontinence pads) is good for the environment and needed to achieve the sustainability goals of many consumer companies. These goals are about using 100% recycled materials and having zero consumer and manufacturing waste go to landfill. In addition to these goals, successful recycling benefits the environment, stimulates the economy, improves people's health and water quality, and generates energy needed by consumers in developing regions of the world.

The components of AHPs are typically SAP, adhesives, elastics, cellulose fibers, polyethylene, polypropylene, and polyester. SAP is a water-absorbing, water-swellable, and water-insoluble powdered solid which is a crosslinked and partially neutralized homopolymer of glacial acrylic acid. SAP has an exceptionally high ability to absorb aqueous liquids, such as contaminated water or urine. Polyethylene, polypropylene, polyester, and adhesives are used in the construction of the AHP, and cellulose fibers are used to absorb fluids similar to the SAP.

Recycling of used AHPs involves cleaning of the AHPs from the soils accumulated during their use and separating the various components into recycled material streams, such as cellulose stream, plastic stream, and SAP stream. Non-limiting examples of processes that produce purified and separated material streams of used SAP from recycled AHPs are disclosed and claimed in U.S. Pat. Nos. 9,095,853 and 9,156,034; both assigned to Fater S.p.A, based in Pescara, Italy. A known limitation is that the streams of recovered cellulose, plastic and SAP, produced via mechanical separation methods, are of lower quality and contain contaminants, therefore making their use back into new AHPs is difficult. For the purpose of recycling used AHPs into building blocks for the chemical industry, such as naphtha, one could consider pyrolysis, which is well known for converting mixed plastic waste into pyrolysis oil to be used along with virgin fossil naphtha in steam crackers: however, used AHPs contain significant amount of oxygen and pyrolysis is well known to be limited to handle only hydrocarbon polymers. Oxygenated polymers would significantly reduce the yield of pyrolysis oil and increase the yield of gases.

Accordingly, there is a need to recycle used AHPs using energy-efficient methods and produce a single material stream from the plastic, cellulose fiber, and SAP components of used AHPs, instead of separate material streams. This single material stream can then be further divided into multiple fractions, with high yield of liquid fractions, such as naphtha, which can be used in typical chemical industry unit operations to produce feedstock chemicals for the various components of AHPs, thus fully recycling used AHPs into new AHPs. However, those fractions, such as naphtha, to be used in typical chemical industry, need to have low content in undesired elements, such as oxygen, chlorine, nitrogen, sulfur. Alternatively, the feedstock chemicals can be used to produce recycled materials for other applications in upcycling or downcycling operations.

### SUMMARY OF THE INVENTION

In embodiments of the present invention, a method for recycling a used absorbent hygiene product (used AHP) is presented. The method comprises feeding said used AHP in an HTT reactor operating at an HTT reactor temperature, at an HTT reactor pressure, and for an HTT reactor residence time; and wherein a liquid product stream from said HTT reactor comprises waste-derived fuel products.

In embodiments of the present invention, a method for recycling a used AHP is presented. The method comprises: 1) size reduction of said used AHP into pieces; 2) feeding said pieces to an extruder to produce a melt stream; 3) providing an aqueous solution; 4) contacting said melt stream with said aqueous solution to produce a mixed stream; 5) feeding said mixed stream in an HTT reactor operating at an HTT reactor temperature, at an HTT reactor pressure, and for an HTT reactor residence time; 6) producing a liquid product stream comprising waste-derived fuel products; and 7) depressurizing and cooling said liquid product stream.

In embodiments of the present invention, a method for recycling a used AHP is presented. The method comprises: 1) size reduction of said used AHP into pieces; 2) providing an aqueous solution; 3) contacting the AHP pieces with the aqueous solution to produce a mixed stream; 4) feeding the mixed stream in an HTT reactor operating at an HTT reactor temperature, an HTT reactor pressure, and for an HTT reactor residence time; 5) producing a liquid product stream comprising waste-derived fuel products; and 6) depressurizing and cooling the liquid product stream.

In embodiments of the present invention, an AHP is presented. The AHP comprises at least one component which has been produced from waste-derived fuel products, wherein said waste-derived fuel products have been produced from recycling a used AHP according to any of the claims above.

### DETAILED DESCRIPTION OF THE INVENTION

I Definitions

As used herein, the term “used AHP” refers to AHP which has already been produced industrially and/or used commercially, for example, as a baby diaper, feminine-protection pad, adult incontinence pad, or other uses. As such, used AHP can be post-industrial recycled AHP (PIR AHP) or post-consumer recycled AHP (PCR AHP).

As used herein, the term “degradation” refers to conversion of a material to a product that comprises low molecular weight hydrocarbon, via mechanisms, such as partial de-polymerization, de-crosslinking, molecular backbone breaking, partial hydrogenation or any combination of the above actions. A non-limiting example of degradation is the conversion of plastic waste to a product containing naphtha and other low molecular weight hydrocarbons in a pyrolysis process. Optionally, the degradation process might include hydrothermal process or hydrogenation of the degradation products.

As used herein, the term “hydrothermal treatment (HTT)” refers to a process in which the organic waste matter is converted into waste-derived fuel product in the presence of water and optionally catalysts at elevated temperatures, such as 250° C. to 500° C., and elevated pressures, such as 0.1 MPa (1 bar) to 30 MPa (300 bar). Under these conditions, water can be in supercritical conditions if its temperature exceeds the critical temperature of water of 374° C. and its pressure exceeds the critical pressure of water of 22.064 MPa (220.6 bar). Alternatively, if the water temperature or pressure are lower than the respective critical temperature and critical pressure then the water is in subcritical conditions.

As used herein, the term “organic matter” refers to a large class of chemical compounds in which one or more atoms of carbon are covalently linked to atoms of other elements, most commonly hydrogen, oxygen, or nitrogen.

As used herein, the terms “waste-derived fuel product” and “waste-derived oil” refer to energy-containing materials derived from the processing of waste materials, such as biomass, plastic waste, etc. and comprising “low molecular weight hydrocarbons”. The waste-derived fuel product is not primarily produced from virgin fossil resources, such as crude oil, natural gas, coal, etc. Non-limiting examples of low molecular weight hydrocarbons are naphtha (typically, C₅ to C₉ hydrocarbons with atmospheric boiling points between about 30° C. and about 200° C.) and diesel (typically, C₉ to C₂₅ hydrocarbons with atmospheric boiling points between about 200° C. and about 350° C.). For the purposes of the present invention, the terms “waste-derived fuel product”, “waste-derived oil”, and “low molecular weight hydrocarbon” are used interchangeably.

As used herein, the term “SAP” refers to crosslinked, partially neutralized, and poly(acrylic acid)-based superabsorbent polymer. SAP examples are disclosed in U.S. Pat. Nos. 8,383,746 and 9,822,203. Typically, SAP is capable of absorbing a 0.9 wt % saline solution at 25° C. at least 10 times its dry weight. The typical absorption mechanism is osmotic pressure. SAP that absorbs water or aqueous solutions becomes a gel.

II Feed Material

Unexpectedly, it has been found that used AHPs (despite the fact that contain oxygenated materials, such as SAP, polyester, cellulose and adhesive) fed into an HTT reactor operating at temperature between about 250° C. and about 500° C., pressure between about 0.1 MPa (1 bar) and about 30 MPa (300 bar), and residence time between about 30 min and 180 min produce a liquid product stream comprising low molecular weight hydrocarbons, similarly to hydrocarbon materials fed to an HTT reactor operated under the same conditions as in AHPs. More specifically, the liquid product stream comprises n-paraffins, isoparaffins, cycloparaffins, olefins, aromatics, or mixtures thereof. The liquid product stream has high caloric value and low content of undesired elements, such as oxygen, chlorine, nitrogen, and sulfur. Without wishing to be bound by any theory, applicants believe that the water in the HTT reactor (from the moisture of the used AHP or water added to the used AHP or water present in the HTT reactor) causes degradation of the AHP components and production of a gas, liquid, and solid product streams. The liquid product stream comprises low-molecular weight hydrocarbons and has low content of undesired elements, such as oxygen, chlorine, nitrogen, sulfur. Also, the liquid product stream comprises fuel components, such as naphtha, diesel, gasoline, or other fuels.

In embodiments of the present invention, the used AHP comprises SAP, cellulose, polyethylene (PE), polypropylene (PP), polyester, and adhesive. SAP, cellulose, polyester, and adhesive contain oxygen. The AHP may be designed with lower mass of oxygen-containing materials, for example the AHP may not contain cellulose and PET and contain PE and PP instead. In embodiments of the present invention, the used AHP comprises cross-linked cellulose. In embodiments of the present invention, the used AHP comprises less than about 20 wt % cellulose. In embodiments of the present invention, the used AHP comprises less than about 15 wt % cellulose. In embodiments of the present invention, the used AHP comprises more than about 20 wt % SAP. In embodiments of the present invention, the used AHP comprises more than about 30 wt % SAP.

In embodiments of the present invention, the feed material comprises a used AHP. In embodiments of the present invention, the used AHP comprises about 60% moisture. In embodiments of the present invention, the used AHP comprises moisture between about 20% and about 90%. In embodiments of the present invention, the used AHP comprises moisture between about 5% and about 50%, and preferably between about 10% and about 30%. This moisture can be part of the urine or other body exudates in the used AHP, preferably inside the SAP, thus favoring an intimate contact between water and SAP for a faster reaction in the HTT reactor.

In embodiments of the present invention, the used AHP is contacted with an aqueous solution. In embodiments of the present invention, the used AHP comprises an aqueous solution. In embodiments of the present invention, the used AHP comprises water. The water in the used AHP can be RO water, regular tap water, or water containing dissolved inorganic salts at various salt concentrations. The used AHP may also be dried, prior to being fed to the HTT reactor, to adjust its water content. More specifically, the used AHP may be dried to water content of less than 100%, more preferably less than about 20%, and most preferably less than about 5%, prior to being fed to the HTT reactor.

The used AHP may contain significant amounts of water. The water removed from the used AHP prior to the feeding of the AHP to the extruder prior to the HTT reactor may be recycled to prepare the aqueous solution. In embodiments of the present invention, the process may not require use of virgin water, as it may recycle the water recovered from the incoming used AHP stream; alternatively, the recovered water, from used AHP, may cover at least about 50% of the water needs of the process.

The used AHP may be dried and reduced to pellets with methods known in the art, such the SFD system, commercially available from Super Faiths Inc. Alternatively, after been dried, the used AHP may be mixed and compounded with other plastic waste and reduced into pellets to be fed into the HTT reactor.

In embodiments of the present invention, the method for recycling a used AHP comprises size reduction of the used AHP into pieces. The size reduction can be of any type known to those skilled in the art. In embodiments of the present invention, the method for recycling a used AHP comprises size reduction of the used AHP into pieces, and wherein said size reduction is selected from the group comprising grinding, chipping, pelletization, granulation, flaking, powdering, shredding, milling, and compression and expansion. In embodiments of the present invention, the used AHP pieces have an average size. In embodiments of the present invention, the average size of the pieces of the used AHP is between about 0.1 mm and about 10 cm. In embodiments of the present invention, the average size of the pieces of the used AHP is between about 1 mm and about 8 cm. In embodiments of the present invention, the average size of the pieces of the used AHP is between about 1 cm and about 6 cm. In embodiments of the present invention, the average size of the pieces of the used AHP is between about 1.5 cm and about 5 cm. Furthermore, the size reduction method can be followed by a method to remove materials, such as halogen.

In embodiments of the present invention, the method for recycling a used AHP comprises: 1) size reduction of the used AHP into pieces, and 2) feeding said pieces to an extruder to produce a melt stream. The melt stream may be made 100% of used AHP or may also contain other waste materials, such as plastic waste, agricultural waste, food waste, mixed waste, depending on considerations like logistics of waste collection. The melt stream may be made of the dried used AHP and mixed plastic waste.

In embodiments of the present invention, the method for recycling a used AHP comprises: 1) size reduction of the used AHP into pieces, 2) providing an aqueous solution, and 3) contacting said melt stream with said aqueous solution to produce a mixed stream. In embodiments of the present invention, the method for recycling a used AHP comprises: 1) size reduction of the used AHP into pieces, 2) feeding said pieces to an extruder to produce a melt stream, 3) providing an aqueous solution, and 4) contacting said melt stream with said aqueous solution to produce a mixed stream. The aqueous solution may not be necessary if the used AHP contains already sufficient amount of water. A base may be added to the used AHP prior to extrusion, prior to making the melt stream, prior to adding the aqueous solution, and/or prior to forming the mixed stream.

The melt stream may exit from the extruder at a pressure between about 2 MPa and about 30 MPa and/or a temperature between about 200° C. and about 380° C. The extruder may be directly connected to the HTT reactor in a manner allowing the mixed stream to flow into the HTT reactor in a continuous flow. In embodiments of the present invention, the mixed stream comprises between about 40 wt % and about 80 wt % used AHP on a dry basis, and between about 20 wt % and about 60 wt % aqueous solution. In embodiments of the present invention, the mixed stream comprises between about 40 wt % and about 80 wt % used AHP and plastic waste on a dry basis, and between about 20 wt % and about 60 wt % aqueous solution, wherein the used AHP and plastic waste composition may be on a dry basis between about 1% of used AHP to about 100% of used AHP, between about 5% of used AHP to about 50% of used AHP. A molar ratio of hydrogen to carbon (H/C) of used AHP and plastic waste composition may be greater than about 2.15, greater than about 1.2, greater than about 1.0, or greater than about 0.8. The aqueous solution may be supercritical prior to said contacting. The aqueous solution may be subcritical prior to said contacting.

If the stream of aqueous solution is not provided, because for example the aqueous solvent is water and there is already enough water in the used AHP, the water may be brought to supercritical conditions in the extruder, prior to being fed to the HTT reactor, or in the HTT reactor.

In embodiments of the present invention, the aqueous solution comprises between about 5 wt % and about 40 wt % alcohol. In embodiments of the present invention, the aqueous solution comprises between about 5 wt % and about 40 wt % alcohol, wherein said alcohol is selected from the group consisting of methanol, ethanol, isopropyl alcohol, isobutyl alcohol, pentyl alcohol, hexanol, iso-hexanol, or any combination thereof. Without wishing to be bound by any theory, it is believed that the use of alcohol may be beneficial to control the swelling level of the SAP, contained in the used AHP. In embodiments of the present invention, the mixed stream comprises a catalyst selected from the group consisting of base catalyst, acid catalyst, water-gas-shift reaction catalyst, aluminosilicate catalyst, sulphide catalyst, or any combination thereof. The catalyst may be added to the mixed stream after the mixed stream has reached the HTT reactor temperature, or after the mixed stream has reached the HTT reactor temperature and the HTT reactor pressure. In addition, intrinsic catalysts may be present in the AHP, or in the vessel walls of the HTT reactor. The mixed stream may comprise between about 5 wt % and about 60 wt % of oil, optionally wherein the oil is recycled from a waste-derived-oil product previously generated in accordance with the method above. The oil may be paraffinic oil, gas-oil, crude oil, synthetic oil, coal-oil, bio-oil, shale oil, kerogen oil, mineral oil, white mineral oil, and aromatic oil.

The mixed stream may contain a solid substrate component, such as coal, coke, tar, char, ash, and mineral. Alternatively, fillers, already intrinsically present in the used AHP, such as calcium carbonate, zeolites, etc. may avoid the use of a solid substrate component.

In embodiments of the present invention, the used AHP is dried prior to its size reduction. In embodiments of the present invention, the dried used AHP has moisture between about 5 wt % and 50 wt %. In embodiments of the present invention, the dried used AHP has moisture between about 10 wt % and 30 wt %.

III HTT Reactor

The HTT reactor can be of any type known to those skilled in the art. A non-limiting example of an HTT reactor is an autoclave. The degradation of a used AHP can be catalytic or non-catalytic, and can proceed in continuous, batch, or semi batch modes. The metal or alloy of construction of the HTT reactor can be stainless steel, carbon steel, or any other suitable metal or alloy. The HTT reactor apparatus may include a blow down valve for the removal of undesirable solids, such as coke, char, precipitated metal halides, calcium carbonate fillers, inorganic salts, metal or inorganic contamination of the feed materials, etc. The addition of a base to the melt stream to the feed materials or mixed stream or reaction mixture may facilitate the formation of solids to be collected from the bottom of the HTT reactor. The HTT reactor may contain various zones with different temperatures, pressures, and residence times to degrade the various AHP components at specific conditions.

The degradation of the used AHPs may be carried out at any suitable temperature and pressure, which is measured in the HTT reactor. Without wishing to be bound by any theory, it is believed that the use of supercritical or subcritical water enables better heat exchange into the AHP, which may otherwise cause inefficient conversion of the used AHP and formation of char. The critical temperature of water is 374° C. and critical pressure of water is 22.064 MPa (220.6 bar).

In embodiments of the present invention, the HTT reactor temperature is between about 250° C. and about 500° C. In embodiments of the present invention, the HTT reactor temperature is about 450° C. In embodiments of the present invention, the HTT reactor temperature is higher than about 300° C. In embodiments of the present invention, the HTT reactor temperature is higher than about 350° C. In embodiments of the present invention, the HTT reactor temperature is higher than about 400° C. In embodiments of the present invention, the HTT reactor temperature is between about 425° C. and 500° C.

In embodiments of the present invention, the HTT reactor pressure is between about 0.1 MPa and about 30 MPa. In embodiments of the present invention, the HTT reactor pressure is between about 0.2 MPa and about 25 MPa. In embodiments of the present invention, the HTT reactor pressure is between about 1 MPa and about 20 MPa. In embodiments of the present invention, the HTT reactor pressure is higher than about 0.2 MPa. In embodiments of the present invention, the HTT reactor pressure is higher than about 1 MPa. In embodiments of the present invention, the HTT reactor pressure is higher than about 3 MPa. In embodiments of the present invention, the HTT reactor pressure is higher than about 10 MPa. In embodiments of the present invention, the HTT reactor pressure is higher than about 23 MPa. In embodiments of the present invention, the HTT reactor pressure is about 0.25 MPa. In embodiments of the present invention, the HTT reactor pressure is about 1.5 MPa. In embodiments of the present invention, the HTT reactor pressure is about 3.8 MPa. In embodiments of the present invention, the HTT reactor pressure is about 23 MPa.

In embodiments of the present invention, the HTT reactor temperature is higher than about 400° C. and the HTT reactor pressure is higher than about 10 MPa. In embodiments of the present invention, the HTT reactor temperature is about 450° C. and the HTT reactor pressure is higher than about 0.25 MPa. In embodiments of the present invention, the HTT reactor temperature is about 450° C. and the HTT reactor pressure is higher than about 1.5 MPa. In embodiments of the present invention, the HTT reactor temperature is about 450° C. and the HTT reactor pressure is higher than about 3.8 MPa. In embodiments of the present invention, the HTT reactor temperature is about 450° C. and the HTT reactor pressure is higher than about 10 MPa. In embodiments of the present invention, the HTT reactor temperature is about 450° C. and the HTT reactor pressure is higher than about 23 MPa.

The HTT reactor residence time is defined as the average time the feed material spends in the HTT reactor, and its value can be of any suitable amount. In embodiments of the present invention, the HTT reactor residence time is higher than about 30 min. In embodiments of the present invention, the HTT reactor residence time is higher than about 45 min. In embodiments of the present invention, the HTT reactor residence time is higher than about 60 min. In embodiments of the present invention, the HTT reactor residence time is higher than about 90 min. In embodiments of the present invention, the HTT reactor residence time is higher than about 120 min. In embodiments of the present invention, the HTT reactor residence time is higher than about 150 min. In embodiments of the present invention, the HTT reactor residence time is between about 30 min and about 180 min. In embodiments of the present invention, the HTT reactor residence time is between about 60 min and about 150 min. In embodiments of the present invention, the HTT reactor residence time is between about 90 min and about 120 min.

IV Liquid Product Stream

The feed material in the HTT reactor produces a gas product stream (with C₅ and lower), a liquid product stream (with C₆ up to C₃₁), and a solid product stream at the outlet of the HTT reactor. In embodiments of the present invention, the gas product stream is between about 5 wt % and about 15 wt % of the total product stream, the liquid product stream is between about 80 wt % and about 90 wt % of the total product stream, and the solid product stream is about 5 wt % or less of the total product stream.

In embodiments of the present invention, the liquid product stream is higher than about 30 wt % of the mixed stream on a dry basis. In embodiments of the present invention, the liquid product stream is higher than about 50 wt % of the mixed stream on a dry basis. In embodiments of the present invention, the liquid product stream is higher than about 60 wt % of the mixed stream on a dry basis. In embodiments of the present invention, the liquid product stream is higher than about 70 wt % of the mixed stream on a dry basis. In embodiments of the present invention, the liquid product stream is higher than about 80 wt % of the mixed stream on a dry basis. In embodiments of the present invention, the liquid product stream has a caloric value higher than about 30 MJ/kg. In embodiments of the present invention, the liquid product stream has a caloric value higher than about 40 MJ/kg. In embodiments of the present invention, the liquid product stream has a caloric value higher than about 45 MJ/kg.

In embodiments of the present invention, the liquid product stream comprises a low molecular weight hydrocarbon. In embodiments of the present invention, the liquid product stream comprises waste-derived fuel products. In embodiments of the present invention, the liquid product stream comprises naphtha. In embodiments of the present invention, the liquid product stream comprises diesel. In embodiments of the present invention, the liquid product stream comprises gasoline.

The waste-derived fuel products may comprise multiple phases, including but not limited to a water-soluble aqueous phase and a water insoluble phase. The water-insoluble phase may also be called oil phase and comprises known fuel fractions, such as naphtha and diesel. The water soluble phase may comprise, compounds including, but not limited to, any one or more of carbohydrates, aldehydes, carboxylic acids, carbohydrates, phenols, furfurals, alkenes, alkanes, aromatic hydrocarbons, styrene, ethylbenzene, alcohols, and ketones, resins and resin acids, and compounds structurally related to resin acids, alkanes and alkenes, fatty acids and fatty acid esters, sterols and sterol-related compounds, furanic oligomers, cyclopentanones, and cyclohexanones, alkyl- and alkoxy-cyclopentanones, and cyclohexanones, cyclopentenones, alkyl- and alkoxy-cyclopentenones, aromatic compounds including naphthalenes and alkyl- and alkoxy-substituted naphthalenes, cresols, alkyl- and alkoxy-phenols, alkyl- and alkoxy-catechols, alkyl- and alkoxy-trihydroxybenzenes, alkyl- and alkoxy-hydroquinones, indenes and indene-derivatives. The water insoluble phase may comprise, compounds including, but not limited to, any one or more of alkenes, alkanes, aromatic hydrocarbons, styrene, ethylbenzene, waxes, aldehydes, carboxylic acids, carbohydrates, phenols, furfurals, alcohols, and ketones, resins and resin acids, and compounds structurally related to resin acids, alkanes and alkenes, fatty acids and fatty acid esters, sterols and sterol-related compounds, furanic oligomers, cyclopentanones, and cyclohexanones, alkyl- and alkoxy cyclopentanones, and cyclohexanones, cyclopentenones, alkyl- and alkoxy-cyclopentenones, aromatic compounds including naphthalenes and alkyl- and alkoxy-substituted naphthalenes, cresols, alkyl- and alkoxy-phenols, alkyl- and alkoxy-catechols, alkyl- and alkoxy-trihydroxybenzenes, alkyl- and alkoxy-hydroquinones, indenes and indene-derivatives. Other non-limiting examples of waste-derived fuel products include oil char (e.g., carbon char with bound oils), char, and gaseous product (e.g., methane, hydrogen, carbon monoxide and/or carbon dioxide, ethane, ethene, propene, propane).

In embodiments of the present invention, the liquid product stream comprises n-paraffins, isoparaffins, cycloparaffins, olefins, and aromatics. In embodiments of the present invention, the n-paraffins are between about 5 wt % and about 30 wt % of the liquid product stream. In embodiments of the present invention, the isoparaffins are between about 4 wt % and about 20 wt % of the liquid product stream. In embodiments of the present invention, the cycloparaffins and olefins are between about 30 wt % and about 40 wt % of the liquid product stream. In embodiments of the present invention, the aromatics are between about 20 wt % and about 30 wt % of the liquid product stream.

In embodiments of the present invention, a method for recycling a used absorbent hygiene product (used AHP) comprises feeding said used AHP in a hydrothermal treatment (HTT) reactor at an HTT reactor temperature, at an HTT reactor pressure, and for an HTT reactor residence time; and wherein a liquid product stream from said HTT reactor comprises waste-derived fuel products. In embodiments of the present invention, a method for recycling a used AHP comprises: 1) size reduction of the used AHP into pieces; 2) feeding the pieces to an extruder to produce a melt stream; 3) providing an aqueous solution; 4) contacting the melt stream with the aqueous solution to produce a mixed stream; 5) feeding the mixed stream in an HTT reactor at an HTT reactor temperature, at an HTT reactor pressure, and for an HTT reactor residence time; 6) producing a liquid product stream comprising waste-derived fuel products; and 7) depressurizing and cooling the liquid product stream.

In embodiments of the present invention, a method for recycling a used AHP comprises: 1) size reduction of the used AHP into pieces; 2) providing an aqueous solution; 3) contacting the AHP pieces with the aqueous solution to produce a mixed stream; 4) feeding the mixed stream in an HTT reactor at an HTT reactor temperature, at an HTT reactor pressure, and for an HTT reactor residence time; 5) producing a liquid product stream comprising waste-derived fuel products; and 6) depressurizing and cooling the liquid product stream.

One or more of the waste-derived fuel products may comprise less than about 10 wt % oxygen, preferably less than about 5 wt % oxygen, more preferably less than about 2 wt % oxygen, even more preferably less than about 0.5 wt % oxygen, and most preferably less than about 0.1 wt % oxygen.

Without wishing to be bound by any theory, it is believed that the use of water in the HTT reactor enables the reduction of the oxygen content in the liquid product stream. This is very important as AHPs may contain materials with significant oxygen content, such as polyester, SAP, cellulose, which would otherwise reduce the value of the waste-derived fuel products. The waste-derived fuel products may be further treated in order to reduce their oxygen content.

One or more of the waste-derived fuel products may contain less than about 5 wt % nitrogen, preferably less than about 1 wt % nitrogen, more preferably less than about 0.5 wt % nitrogen, and most preferably less than about 0.1 wt % nitrogen. Without wishing to be bound by any theory, it is believed that the use of water in the HTT reactor enables the reduction of the nitrogen content in the liquid product stream. This is very important as AHPs may contain significant nitrogen content, such as urea contained in the human exudates, which would otherwise reduce the value of the waste-derived fuel products. In addition reducing nitrogen content in one or more of the waste-derived fuel products may be achieved via removing, at least partly, urea contained in human exudates: this may be done for example subjecting the used AHP to a pre-treatment to de-swell the SAP, for example with a calcium compound or an organic acid solution as known in the art (U.S. Pat. No. 9,777,131; and U.S. Patent Application US 2017/0107667), then removing the urea from the liquid phase with methods known in the art, such as those used in wastewater treatment, e.g. electrochemical oxidation, adsorption, biological treatment, hydrolysis. In addition, the diaper design may be made such as to reduce the content of nitrogen, for example replacing the polyurethane based components, such as the elastics, with synthetic rubber-based components. The waste-derived fuel products may be further treated in order to reduce the nitrogen content. waste-derived

One or more of the waste-derived fuel products may contain less than about 1 wt % chlorine, preferably less than about 0.1 wt % chlorine, more preferably less than about 0.01 wt % chlorine, and most preferably less than about 0.005 wt % chlorine. Used AHP may contain significant amount of chlorine due to the salts, such as sodium chlorides, contained in the human exudates. Without wishing to be bound by any theory, being salts, like sodium chlorides, water soluble, they may preferably partition into the water-soluble aqueous phase, hence yielding a water insoluble liquid phase with lesser chlorine content. In addition, the transfer of halogens, such as chlorine, present in the reaction mixture to the water-soluble aqueous phase as inorganic halides may reduce issues around dioxin formation. In addition reducing chlorine content in one or more of the waste-derived fuel products may be achieved via removing, at least partly, chlorides contained in human exudates absorbed in the AHPs: this may be done for example subjecting the used AHP to a pre-treatment to de-swell the SAP, for example with a calcium compound or an organic acid solution as known in the art (U.S. Pat. No. 9,777,131; and U.S. Patent Application US 2017/0107667), then removing the chlorides from the water phase with methods known in the art, such as reverse osmosis, distillation or electro-dialysis. In addition, the diaper design may be made such as to reduce the content of chlorine, for example avoiding chlorine containing polymers and additives in the formulation of the AHP. The waste-derived fuel products may be further treated in order to reduce the chlorine content.

One or more of the waste-derived fuel products may contain less than about 1 wt % sulfur, preferably less than about 0.1 wt % sulfur, more preferably less than about 0.01 wt % sulfur, and most preferably less than about 0.005 wt % sulfur. Used AHP may contain significant amount of sulfur due to sulfur containing compounds contained in the human exudates, for example sulfates, cystine. Without wishing to be bound by any theory, being these sulfur containing compounds water soluble, they may preferably partition into the water-soluble aqueous phase, hence yielding a water insoluble liquid phase with lesser sulfur content. In addition reducing sulfur content in one or more of the waste-derived fuel products may be achieved via removing, at least partly, sulfur compounds contained in the human exudates, absorbed by the AHPs: this may be done for example subjecting the used AHP to a pre-treatment to de-swell the SAP, for example with a calcium compound or an organic acid solution as known in the art (U.S. Pat. No. 9,777,131; and U.S. Patent Application US 2017/0107667), then removing the sulfur compounds from the liquid phase with methods known in the art, such as reverse osmosis. In addition, the diaper design may be made such as to reduce the content of sulfur, for example avoiding sulfur containing polymers and additives in the formulation of the AHP. The waste-derived fuel products may be further treated in order to reduce the sulfur content.

After depressurizing and cooling the waste-derived fuel products, they may be subjected to further separation techniques to recover one or more of a gaseous, aqueous, oil, and/or wax component from the product, and/or separating one or more fractions of an oil, and/or one or more fractions of a wax component from the product. For example, upon depressurization and cooling the synthetic crude oil will separate from the water in the flash tank and float on the water, being of lower density that water. Gas and vapor will also be separated at this point. The gas will be calorific and can be combusted to provide energy to the process. The separation of the two liquid phases can be further improved by use of, for example, a centrifuge. The oil phase can be subjected to further processing, for example it can be distilled to provide fractions such as naphtha, middle distillates, heavy gas oils and vacuum gas oils, and waxes. Waxes and partly converted polymers may option ally be recycled as feed to the front of the process for further cracking. Naphtha and other fractions may optionally be added to the reaction mixture, for example by injection after the extruder barrel or after the mixing piece, to act as solvents to lower the fluid viscosity and modify the phase behavior.

Waste-derived fuel products can be separated and recycled into one or more fractions having a boiling point between about 30° C. and about 140° C., between about 60° C. and about 160° C., between about 140° C. and about 205° C., between about 150° C. and about 300° C., or between about 230° C. and about 350° C. For example, waste-derived fuel products can be separated and recycled into one or more fractions of the product comprising a wax or a waxy oil having a boiling point above 370° C. atmospheric equivalent boiling point (AEBP), above 400° C. AEBP, above 450° C. AEBP, above 500° C. AEBP, or above 550° C. AEBP.

An additional benefit of the present invention is the reduced formation of char, which is undesired as valuable carbon is subtracted from the more valuable water insoluble liquid phase, which comprises naphtha and diesel. Without wishing to be bound by any theory, it is believed that the use of water in an HTT reactor reduces the formation of char, in particular from cellulosic materials but also from synthetic polymer materials, contained in the AHP.

Further the method comprises separating and recycling a fraction of the waste-derived fuel products having a boiling point in the range of: naphtha boiling range, heavy naphtha boiling range, kerosene boiling range, diesel boiling range, heavy gas oil boiling range, or vacuum gas oil boiling range. Typically, the waste-derived fuel products have lower average molecular weight than the polymeric materials, comprised in the used AHP, prior to conversion. Further any of the fractions above may be combusted to provide heat for repeating the method.

V Recycled AHP

The liquid product stream can be fed into a steam cracker to produce ethylene, propylene, and other chemicals that can be used to produce polyethylene, polypropylene, polyester, adhesives, SAP, etc. which can form a recycled AHP. A waste-derived fuel product may be further processed to be made compatible with a cracker unit to obtain base monomers, such as ethylene and propylene, which may then be used to produce new polymers, such as polyethylene, polypropylene, polyacrylate, etc., which may be used to produce new diapers or other market products or packaging.

In embodiments of the present invention, an absorbent hygiene product (AHP) comprises at least one component which has been produced from waste-derived fuel products, wherein the waste-derived fuel products have been produced from recycling a used AHP according to any of the embodiments above.

The foregoing description is given for clearness of understanding only, and no unnecessary limitations should be understood therefrom, as modifications within the scope of the invention may be apparent to those having ordinary skill in the art.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, comprising any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for recycling a used absorbent hygiene product (used AHP) comprising feeding said used AHP in a hydrothermal treatment (HTT) reactor operating at an HTT reactor temperature, at an HTT reactor pressure, and for an HTT reactor residence time; and wherein a liquid product stream from said HTT reactor comprises waste-derived fuel products.

2. The method of claim 1, wherein said method comprises a size reduction of said used AHP into pieces.

3. The method of claim 1, wherein said used AHP is contacted with an aqueous solution.

4. The method of claim 1, wherein said HTT reactor temperature is higher than about 400° C.

5. The method of claim 1, wherein said HTT reactor pressure is higher than about 23 MPa.

6. The method of claim 1, wherein said HTT reactor residence time is higher than about 30 min.

7. The method of claim 1, wherein the liquid product stream comprises naphtha.

8. A method for recycling a used AHP comprising: 1) size reduction of said used AHP into pieces; 2) feeding said pieces to an extruder to produce a melt stream; 3) providing an aqueous solution; 4) contacting said melt stream with said aqueous solution to produce a mixed stream; 5) feeding said mixed stream in an HTT reactor operating at an HTT reactor temperature, at an HTT reactor pressure, and for an HTT reactor residence time; 6) producing a liquid product stream comprising waste-derived fuel products; and 7) depressurizing and cooling said liquid product stream.

9. The method of claim 8, wherein said reduction is selected from the group comprising grinding, chipping, pelletization, granulation, flaking, powdering, shredding, milling, and compression and expansion.

10. The method of claim 8, wherein said used AHP pieces have an average size; and wherein said average size is between about 0.1 mm and about 10 cm.

11. The method of claim 8, wherein said mixed stream comprises between about 40 wt % and about 80 wt % used AHP on a dry basis and between about 20 wt % and about 60 wt % aqueous solution.

12. The method of claim 8, wherein said aqueous solution comprises between about 5 wt % and about 40 wt % alcohol.

13. The method of claim 8, wherein said used AHP comprises less than about 20 wt % cellulose.

14. A method for recycling a used AHP comprising: 1) size reduction of said used AHP into pieces; 2) providing an aqueous solution; 3) contacting the AHP pieces with the aqueous solution to produce a mixed stream; 4) feeding the mixed stream in an HTT reactor operating at an HTT reactor temperature, at an HTT reactor pressure, and for an HTT reactor residence time; 5) producing a liquid product stream comprising waste-derived fuel products; and 6) depressurizing and cooling the liquid product stream.

15. The method of claim 14, wherein said used AHP pieces have an average size; and wherein said average size is between about 0.1 mm and about 10 cm.

16. The method of claim 14, wherein said HTT reactor temperature is higher than about 400° C.

17. The method of claim 14, wherein said HTT reactor pressure is higher than about 23 MPa.

18. The method of claim 14, wherein said mixed stream comprises between about 40 wt % and about 80 wt % used AHP on a dry basis and between about 20 wt % and about 60 wt % aqueous solution.

19. The method of claim 14, wherein said liquid product stream comprises waste-derived fuel products.

20. An AHP comprising at least one component which has been produced from waste-derived fuel products, wherein said waste-derived fuel products have been produced from recycling a used AHP according to any of the claims above.
